(19) United States
(12) Patent Application Publication
(10) Pub. No.: US 2024/0394583 A1
(43) Pub. Date: Nov. 28, 2024

(54) WARM START OF QUADRATIC UNCONSTRAINED BINARY OPTIMIZATION EXECUTIONS USING SIMILARITIES WITH PAST EXECUTIONS

(71) Applicant: Dell Products L.P., Round Rock, TX (US)

(72) Inventors: Rômulo Teixeira de Abreu Pinho, Niterói (BR); Miguel Paredes Quiñones, Campinas (BR); Ítalo Gomes Santana, Rio de Janeiro (BR); Brendan Burns Healy, Haddonfield, NJ (US)

(21) Appl. No.: 18/321,286

(22) Filed: May 22, 2023

(51) Int. Cl. G06N 10/60; G06F 17/16

(52) U.S. Cl. CPC G06N 10/60; G06F 17/16

(57) ABSTRACT

Warm-starting quantum jobs is disclosed. When solving a quantum job, a database is consulted to identify transactions that include QUBO (quadratic unconstrained binary optimization) configurations that are the most similar to the QUBO configuration of the quantum job being solved. An annealer identified in a selected transaction is used to perform the quantum job and a solution associated with the selected transaction is incorporated into the current QUBO configuration to generate a warm start QUBO configuration. The warm start QUBO configuration is executed on the quantum annealer in the selected transaction. The solution to the quantum job, along with the warm start QUBO configuration and annealer are added to the database as a new transaction.

### FIELD OF THE INVENTION

Embodiments of the present invention generally relate to quantum computing systems and to performing operations related to executing quantum jobs. More particularly, at least some embodiments of the invention relate to systems, hardware, software, computer-readable media, and methods for more efficiently executing quantum jobs.

### BACKGROUND

Quantum computing systems/devices, such as a quantum annealers, can often solve problems more quickly and efficiently than classical computing systems. For example, quantum annealers perform well when solving optimization or combinatorial (hereinafter optimization) problems. More specifically, for an optimization problem that has a very large solution space, a quantum annealer can often find a suitable solution more quickly than classical computing systems.

One of the issues related to finding solutions to optimization problems relates to the time required to generate the solutions. When solving an optimization problem, a quantum job may be submitted for execution. The quantum job includes smaller jobs that are performed as part of the overall execution of the quantum job. Some of these smaller jobs are, by themselves, optimization problems. For example, executing a quantum job requires the optimization problem represented in the quantum job to be expressed in a particular form or format.

Additional aspects of performing a quantum job including compiling the problem into a matrix configuration, graphing the matrix representation, mapping the graph to a compatible quantum computing system, and finally, executing the quantum job on the quantum computing system. The overall process of executing a quantum job can require substantial time that increases with the complexity of the problem to be solved.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIGS. 1A, 1B, and 1C disclose aspects of executing a quantum job;

FIG. 2 discloses aspects of executing a quantum job with a warm start and disclose aspects of identifying or generating the warm start;

FIG. 3 discloses aspects of generating embedded matrices to facilitate selection of matrix configurations that are similar to a current matrix configuration;

FIG. 4 discloses aspects of warm starting a quantum job; and

FIG. 5 discloses aspects of a computing device, system, or entity.

### DETAILED DESCRIPTION OF SOME EXAMPLE EMBODIMENTS

Embodiments of the present invention generally relate to quantum computing system and to executing quantum jobs. More particularly, at least some embodiments of the invention relate to systems, hardware, software, computer-readable media, and methods for efficiently executing a quantum job with a warm start. A warm start, in one example, may be configured to reduce the time needed to find a solution by altering the quantum job to account for work done in solving similar quantum jobs. For example, a matrix configuration may be adapted based on the matrix configurations of similarly situated quantum jobs.

Quantum computing (hardware based) systems such as quantum annealers are capable of solving a variety of problems including optimization and combinatorial problems. These types of problems are often expressed as quadratic unconstrained binary optimization (QUBO) problems, which are a specific class of problems that can be solved using quantum annealers. These problems are often expressed as or referred to herein as a quantum jobs.

Once a quantum job is prepared or identified, the quantum job may be submitted to an orchestration engine. The orchestration engine orchestrates execution of the quantum job. However, a quantum job is composed of smaller jobs that may also be orchestrated. Many of these smaller jobs are performed in classical computing systems (e.g., nodes or systems that may include processors, memory, networking hardware, etc.). Although embodiments of the invention are discussed in the context of QUBO problems, embodiments of the invention are not limited thereto.

An optimization problem may be expressed using multiple variables that are binary in nature (e.g., minimize y=−5x₁−3x₂−8x₃−6x₄+4x₁x₂+8x₁x₃+2x₂x₃+10x₃x₄). A model of the problem can also be expressed in matrix form, which is generally represented as

$${min}_{x ∈ {\{ 0 , 1 \}}^{n}} {x}^{T} Qx .$$

Generally, quantum annealing interpolates between a static problem-independent Hamiltonian for which a ground state can be efficiently prepared and a final Hamiltonian whose ground state yields a desired solution. A quantum annealing system interpolated between H₀ and H_{f}(H₀=Q). Thus, H(t)=α(t)H₀+β(t)H_{f}. In this example, H_{f} is the Hamiltonian of the problem to be solved.

Embodiments of the invention relate to improving the efficiency of performing a quantum job by providing a warm start to the execution of the quantum job and more specifically to the execution of the Hamiltonian or QUBO configuration. In one example, a database of previously executed quantum jobs (QUBO configurations) is maintained. The database stores transactions that include the solutions to the quantum jobs. When a new quantum job is being processed or prepared for execution, the database may be searched to identify candidate quantum jobs that are most similar to the current quantum job. One of the candidates is selected and the solution to the selected candidate is incorporated into the current quantum job. In this manner, the current quantum job is configured to account for or start from the solution of a previously solved quantum job. This provides a warm start to the execution of the quantum job and can reduce the execution time.

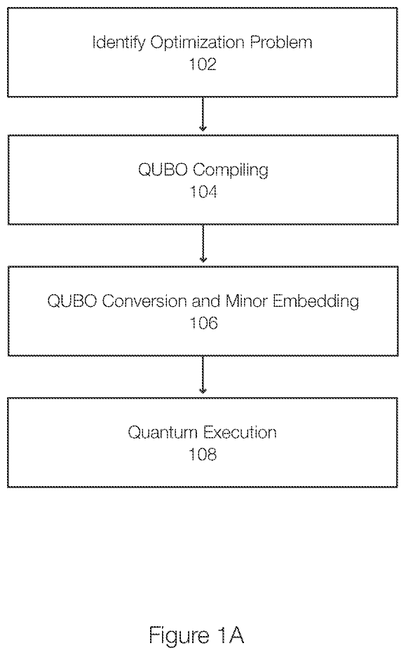

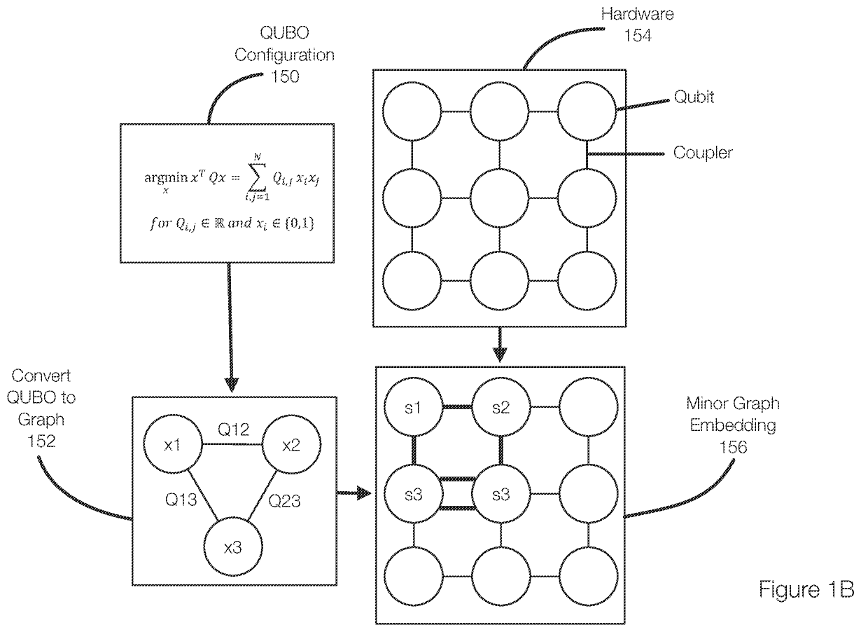

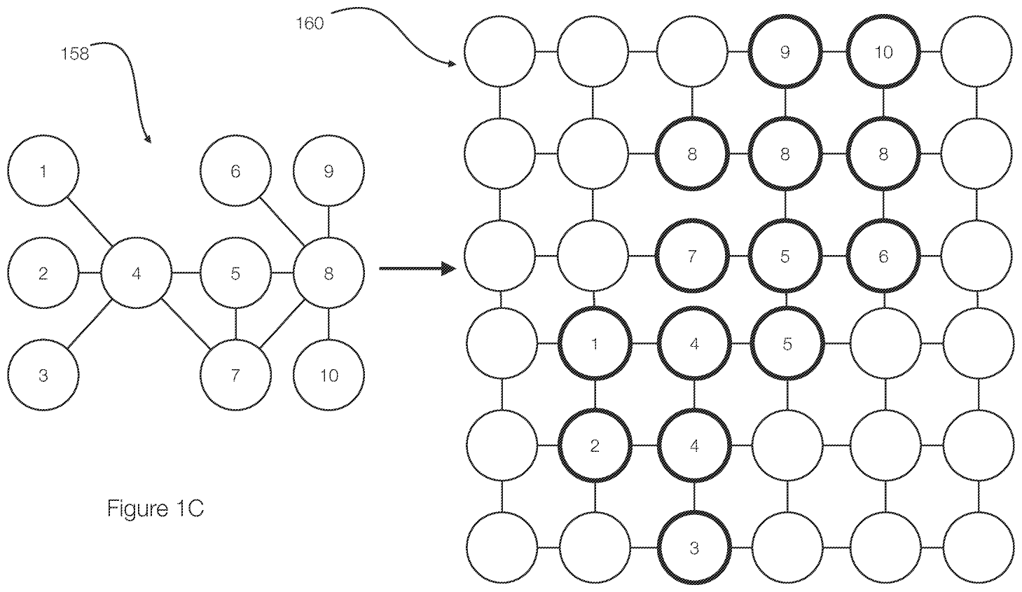

FIG. 1A discloses aspects of solving optimization problems or executing quantum jobs using classical and/or quantum computing systems (e.g., CPU, GPU, QPU). Generally, the process begins by identifying 102 a problem (e.g., optimization, combinatorial) to be solved. Identifying 102 a problem may include defining a problem instance, encoding variables, determining variables, and the like. Once the problem is defined, QUBO compiling 104 is performed. Compiling may include placing the problem or the representation of the problem into a QUBO format in preparation for submitting the quantum job (or the QUBO) to a quantum annealer. The output of QUBO compiling may be or include a QUBO or matrix configuration.

For example, a QUBO or QUBO configuration may be defined as follows after the problem is identified and the QUBO is compiled:

$${arg min}_{x} {x}^{T} Qx = {\sum }_{i , j = 1}^{N} {Q}_{i , j} {x}_{i} {x}_{j} for {Q}_{i , j} ∈ ℝ and {x}_{i} ∈ \{ 0 , 1 \} .$$

Once the QUBO is formulated, the QUBO configuration may be converted to a graph and minor embedding 106 is performed. By way of example, minor embedding is a process of mapping the graph to the physical hardware of the quantum system. In effect, the qubits of the logical problem are mapped to the qubits of the quantum computing system.

FIG. 1B illustrates an example of converting a QUBO to a graph and performing a minor embedding operation. In this example, a QUBO 150 is converted into a graph 152. The minor embedding operation 156 is performed by mapping the graph 152 to the hardware 154 of the quantum system.

FIG. 1C further illustrates aspects of performing a minor graph embedding operation. In FIG. 1C, a graph 158 is embedded or translated to the hardware 160 of a quantum computing system such as a quantum annealer.

Aspects of quantum annealing are disclosed in Quantum Annealing for Industry Applications: Introduction and Review, Sheir Yarkoni et al 2022 Rep. Prog. Phys. 85 104001, which is incorporated by reference in its entirety.

Once the QUBO graph is mapped to the physical hardware, the quantum computing system may be initialized (set to a particular energy state) and quantum execution 108 may be performed to solve the QUBO. The solution is represented in the final state of the quantum computing system.

In the context of warm starts, the minor embedding problem is relevant at least because the warm start may incorporate a QUBO configuration and it is useful to ensure that the quantum annealer is compatible with the warm-start QUBO configuration or matrix.

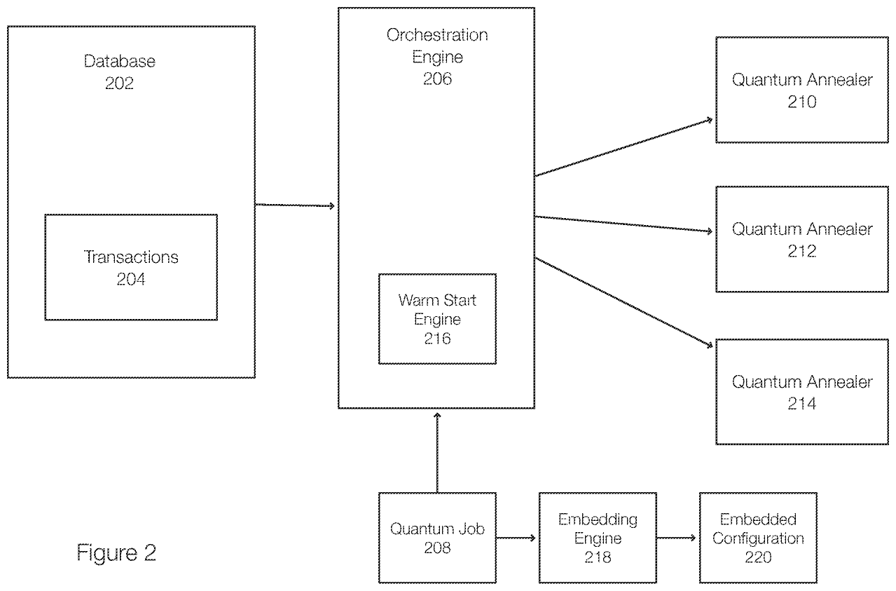

FIG. 2 discloses aspects of executing a quantum job with a warm start or of determining the warm start for the quantum job. FIG. 2 illustrates an orchestration engine 206 that is configured to orchestrate the execution of quantum jobs. For example, when a quantum job 208 is received at the orchestration engine 206, the orchestration engine 206 orchestrates the various smaller jobs relevant to the overall execution of the quantum job 208. This may include compiling the quantum job to generate a QUBO configuration. Orchestrating the compilation of the quantum job 208 may include identifying the compilation portion, placing the compilation job at a node or at classical computing resources. The orchestration engine 202 may also orchestrate execution of the quantum job after compilation by placing the annealing job (the portion executed by a quantum computing system) with a quantum computing system.

FIG. 2 illustrates aspects of the quantum job related to providing a warm start to the execution of the quantum job. In this example, the orchestration engine 202 includes or has access to a database 202 that stores transactions 204. Each of the transactions may be represented as follows: {Qᵢ, xᵢ, Aᵢ, Pᵢ}. In this example, Qᵢ identifies or includes a QUBO configuration (e.g., QUBO matrices (e.g., Hamiltonian)) and the associated solution x*ᵢ after the QUBO configuration is executed on some annealer Aᵢ on a set of input parameters Pᵢ (number of sweeps, number of reads, beta values, or the like).

When the orchestration engine 206 receives a quantum job 208, and at the appropriate time (e.g., after compilation or after the QUBO configuration is formulated), the warm start engine 216 may query the transactions 204 in the database 202 to identify the k most similar QUBO configurations that were previously executed and the associated quantum annealers. In this example, k may be set by a user or by default.

The orchestration engine 216 uses the k quantum annealers as an initial candidate list. For example, if k=3, the initial list of candidate quantum annealers for executing the quantum job 208 may include the quantum annealers 210, 212, and 214. Other quantum annealers may be available to the orchestration engine 206. The orchestration engine 206 may evaluate the quantum annealers 210, 212, and 214 to determine whether they are compatible with the quantum job 208. For example, the QUBO configuration of the quantum job 208 may not map to the quantum annealer 214. The quantum annealer 212 may not satisfy service level objectives. Thus, the orchestration engine 206 may select the quantum annealer 210 for executing the quantum job 208 or for executing, more specifically, the QUBO configuration.

In addition to selecting a quantum annealer from the list of candidate quantum annealers identified from the top k similar transactions, the solution in the transaction corresponding to the selected quantum annealer may be incorporated or included in the QUBO configuration to provide the quantum annealer with a warm start. Embodiments of the invention improve the efficiency of performing or executing the quantum job by selecting a quantum annealer that previously executed a similar QUBO and by seeding the QUBO configuration with the previous solution, both of which contribute to the warm start.

Thus, instead of submitting the quantum job 208 (or the annealing job represented by the QUBO configuration) directly to the selected quantum annealer 210 in this example, the solution xᵢ is retrieved from the database 202 and used as an initial solution and Hamiltonian for the current QUBO problem with matrix Q using the input parameters Pᵢ.

The warm start at t=0 of the annealing process for the quantum job 208 (the matrix Q on the quantum annealer 210(A) using solution x*ᵢ and Hamiltonian Qᵢ is defined as follows:

$$H ( t = 0 , x = {x}_{i}^{*} ) = α ( t ) \cdot ( {x}^{T} {Q}_{i} x ) + β ( t ) \cdot ( {x}^{T} Qx ) .$$

In this example, (x^{T}Qᵢx) is the initial Hamiltonian and (x^{T}Qx) is the final Hamiltonian. In this example, α(t) is the coefficient of the initial Hamiltonian and β(t) is the coefficient of the final Hamiltonian. When a real quantum computing system is employed or used, the implementation of the initial Hamiltonian Qᵢ is analyzed to ensure that the selected quantum annealer is compatible with the initial Hamiltonian. For simulated or virtual quantum annealers, initiating on Qᵢ is feasible.

This illustrates that information in the transaction associated with the selected quantum annealer can be used to provide a warm start, which may reduce execution time and thus improve efficiency.

In one example, identifying the k similar transactions may require comparisons between the current QUBO configuration and the k QUBO configurations. To adequately compare QUBO configurations without noise being introduced due to coefficient size, all of the QUBO configurations in the database may be scaled to the point where the largest coefficient is the same uniform value, which may be 1 in some examples.

Embodiments of the invention further relate to an embedding mechanism to make queries to the database 202 more efficient. In one example, the embedding mechanism is configured to project the QUBO configuration or matrices to a lower dimension.

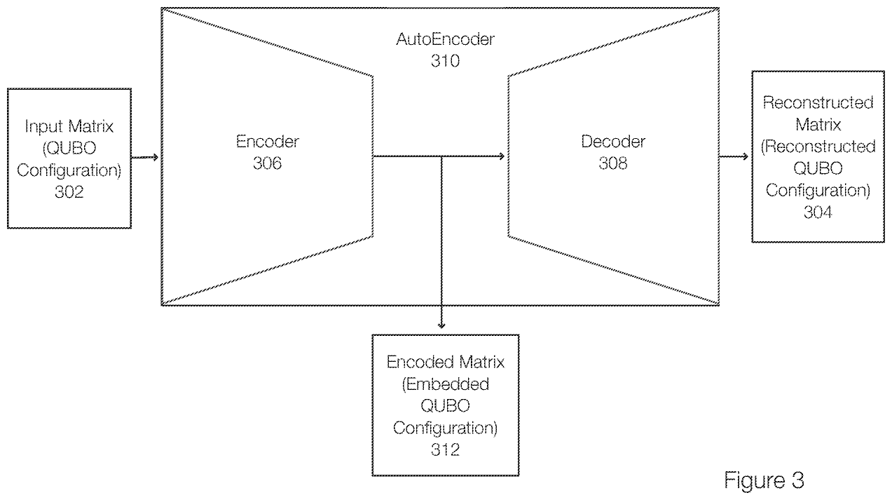

FIG. 3 discloses aspects of an embedding mechanism. In one example, the embedding mechanism is an autoencoder 310 that includes an encoder 306 and a decoder 308. The autoencoder 310 is trained using multiple QUBO configurations, which are represented by an input matrix 302 (e.g., matrix or QUBO configuration Q). The autoencoder 310 is trained when the reconstructed QUBO or reconstructed matrix 304 is within a specified or desired tolerance. In one example, the goal is to train the autoencoder 310 such that the reconstructed matrix 304 is reconstructed to its full dimensionality with very low error. In one example, data samples (e.g., the input matrix 302) that are similar in the original data space tend to be similar in the embedded space. During operation, the encoder 306 embeds the input matrix to an embedded or encoded matrix or from an input QUBO configuration to an embedded QUBO configuration.

The autoencoder 310 is configured to project the input matrix 302 onto a lower-dimensional representation, represented as the encoded matrix 312. More specifically, historical QUBO configuration matrices are obtained and used to train the autoencoder 310. These historical matrices may have different sizes/dimensions.

In one example, the input set of matrices used for training purposes may all be scaled to have the same dimensionality (e.g., D×D). The autoencoder 310 is then trained with the scaled matrices as input. The output of the encoder 306 is an example of an embedded space with dimension d, where d<<D². If a matrix or QUBO configuration in the input set or training set is smaller than D×D, the matrix or QUBO configuration is upscaled to D×D or embedded in that size. After the autoencoder 310 is trained, the decoder 308 can optionally be discarded as the purpose of the autoencoder 310 or embedding mechanism is to generate encoded matrices (or embedded QUBO configurations), which are represented by the encoded matrix 312.

Once the QUBO configurations in the database 202 have been encoded or embedded in this manner, the QUBO configurations Qᵢ in the database are replaced with embedded configurations Eᵢ, which are generated by the trained encoder 306.

Returning to FIG. 2, the orchestration engine 206 has access to or includes an embedding engine 218, which is an example of an embedding mechanism such as the encoder 306.

When the orchestration engine 206 receives the quantum job 208, the orchestration engine 206 resizes or scales the QUBO configuration (e.g., QUBO matrix) associated with the quantum job 208 to D×D dimensionality. The embedding engine 218 is then accessed to generate an embedded configuration 220 for the scaled QUBO configuration of the quantum job 208. The embedded configuration 220 is used by the orchestration engine 206 to search the transactions 204 stored in the database 202. Because the embedded configuration 220(E) is a unidimensional vector in one example, similar transactions or similar embedded configurations stored in the transactions 204 can be identified using, by way of example, a cosine distance metric.

The orchestration engine 206 identifies k similar embedded QUBO configurations from the database 202 and then assigns the quantum job 208 to one of the quantum annealers identified in the k transactions. As previously stated, the solution associated with the selected quantum annealer is incorporated into the QUBO configuration to generate a warm start QUBO configuration.

If the quantum annealers in the list of candidate quantum annealers cannot be used (e.g., they are not compatible or are being used), the orchestration engine 206 may use a different quantum annealer. After executing the quantum job 208 on the selected quantum annealer and obtaining a solution, the orchestration engine 206 stores the solution {E, x, A, P} in the database 202 as a transaction. Thus, the execution and solution of the quantum job 208 is available for use in executing subsequent quantum jobs received by the orchestration engine 206.

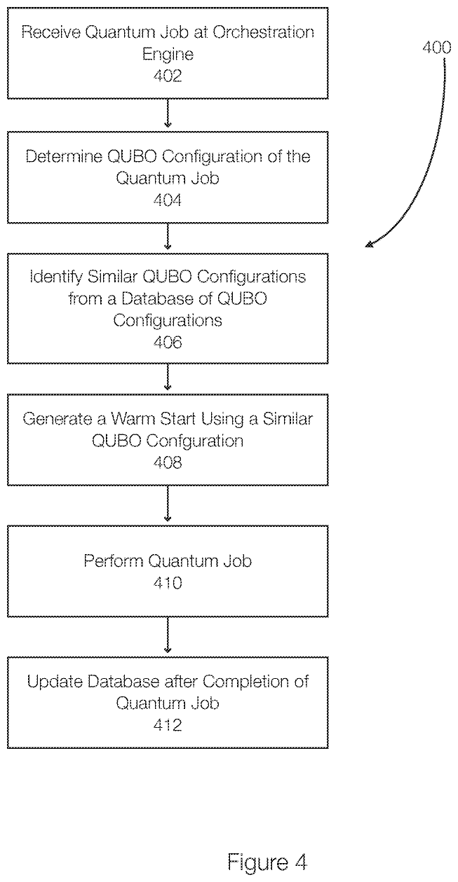

FIG. 4 discloses aspects of a method for warm-starting a quantum job or, more specifically, warm-starting execution of a QUBO configuration in a quantum computing system. The method 400 includes receiving 402 a quantum job at an orchestration engine. Once the quantum job is received, various smaller jobs, which are part of the overall quantum job, are performed. One of the jobs includes determining 404 a QUBO configuration of the quantum job. This is often achieved by compiling the quantum job in classical hardware to generate the QUBO configuration. The QUBO configuration (or matrix configuration) may include a matrix or matrices associated with an optimization problem represented or included in the quantum job.

The orchestration engine uses the QUBO configuration to identify similar QUBO configurations from a database of QUBO configurations, which are stored in transactions in the database. In one example, the top k similar QUBO configurations are identified. In one example, the QUBO configurations stored in the database embedded QUBO configurations such that they have the same dimensionality. The QUBO configuration being searched may also be embedded prior to searching the transactions such that the comparisons performed to identify the most similar embedded QUBO configurations are comparing the same sized matrices. This allows a distance metric, such as cosine distance metric, to be used to identify the k similar embedded QUBO configurations.

In one example, the most similar transaction (which may include the most similar embedded QUBO configuration to the current embedded QUBO configuration) is selected to be used to warm-start the quantum job. In one example, the ability of the quantum annealer identified in the selected transaction is evaluated to ensure that the quantum annealer is compatible. Then, the solution included in the selected transaction is incorporated into the QUBO configuration to be solved. Once the warm-start QUBO configuration is generated, the quantum job (or the warm-start QUBO configuration is performed 410 to determine a solution to the quantum job.

In one example, the database is updated 412 to include a transaction representing the quantum job that was just performed and solved. Updating the database may include embedding the QUBO configuration and/or the warm-start QUBO configuration. The solution is also included in the transaction.

Embodiments of the invention provide operations that allow quantum or QUBO jobs to be performed on quantum annealers (real or simulated) using previous QUBO solutions as warm starts for the QUBO job being performed.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods, processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, operations which may include, but are not limited to, quantum job operations, quantum job orchestration operations, warm start operations, matrix similarity determination operations, embedding operations, feasibility operations, compilation operations, QUBO execution related operations, or the like. More generally, the scope of the invention embraces any operating environment in which the disclosed concepts may be useful.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment.

Example cloud computing environments, which may or may not be public, include storage environments that may provide data functionality. Another example of a cloud computing environment is one in which processing, data protection, and other services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients or nodes that are capable of collecting, modifying, and creating, data. As such, a particular client or node may employ, or otherwise be associated with, one or more instances of each of one or more applications that perform such operations with respect to data. Such clients or nodes may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data system components such as databases, storage servers, storage volumes (LUNs), storage disks, replication services, backup servers, restore servers, backup clients, and restore clients, for example, may likewise take the form of software, physical machines or virtual machines (VM), though no particular component implementation is required for any embodiment.

It is noted with respect to the disclosed methods, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in any way.

Embodiment 1. A method comprising: receiving a quantum job at an orchestration engine, determining a current matrix configuration associated with the quantum job, identifying transactions stored in a database that include matrix configurations similar to the current matrix configuration, selecting a first transaction from the transactions, generating a warm start matrix configuration that includes a solution associated with a first matrix configuration stored in the first transaction, and executing the warm start matrix configuration in a quantum annealer identified in the first transaction.

Embodiment 2. The method of embodiment 1, wherein the current matrix configuration comprises a QUBO configuration.

Embodiment 3. The method of embodiment 1 and/or 2, wherein each of the transactions comprises a QUBO configuration, a quantum annealer, a solution, and parameters.

Embodiment 4. The method of embodiment 1, 2, and/or 3, further comprising incorporating the solution included in the first transaction into the QUBO configuration to generate the warm start configuration, which includes a warm-start QUBO configuration.

Embodiment 5. The method of embodiment 1, 2, 3, and/or 4, wherein the warm-start QUBO configuration is represented as: H (t=0,x*ᵢ)=α(t)·(x^{T}Qᵢx)+β(t)·(x^{T}Qx).

Embodiment 6. The method of embodiment 1, 2, 3, 4, and/or 5, further comprising generating embedded QUBO configurations using an embedding mechanism, wherein the transactions include the embedded QUBO configurations.

Embodiment 7. The method of embodiment 1, 2, 3, 4, and/or 5, further comprising training the embedding mechanism using historical QUBO configurations, wherein the embedding mechanism comprises an autoencoder and wherein an encoder generates embedded QUBO configurations once trained, wherein QUBO configurations input to the encoder are scaled to a same dimension.

Embodiment 8. The method of embodiment 1, 2, 3, and/or 7, further comprising generating a current embedded QUBO configuration from the current matrix configuration, wherein the transactions are identified by comparing the current embedded QUBO configuration with embedded QUBO configurations stored in the transactions.

Embodiment 9. The method of embodiment 1, 2, 3, 4, 5, 6, 7, and/or 8, further comprising identifying k similar transactions based on a cosine distance metric.

Embodiment 10. The method of embodiment 1, 2, 3, 4, 5, 6, 7, 8, and/or 9, further comprising updating the database with a new transaction that includes the warm start matrix configuration, the quantum annealer, a solution to the current quantum job, and parameters.

Embodiment 11 A system, comprising hardware and/or software, operable to perform any of the operations, methods, or processes, or any portion of any of these, disclosed herein.

Embodiment 12 A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

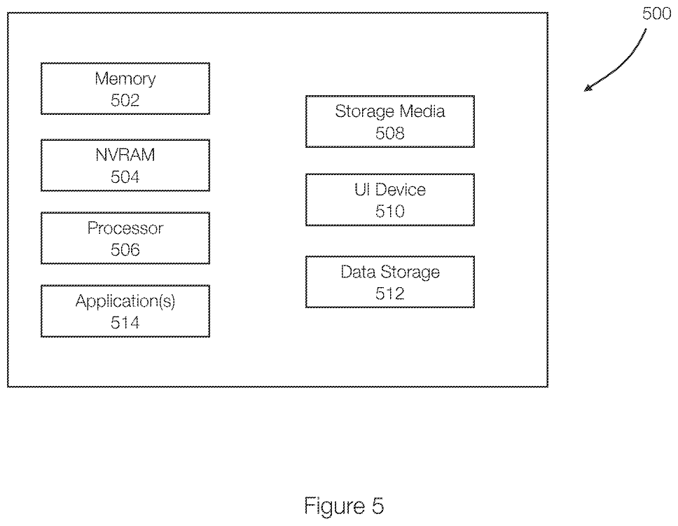

With reference briefly now to FIG. 5, any one or more of the entities disclosed, or implied, by the Figures and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 5 includes a memory 5 which may include one, some, or all, of random-access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid-state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 500 is representative of classical computing systems, nodes, servers, clusters, virtual computers, or the like or combination thereof. The device 500 may also implement a virtual quantum system in a classical system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
receiving a quantum job at an orchestration engine;
determining a current matrix configuration associated with the quantum job;
identifying transactions stored in a database that include matrix configurations similar to the current matrix configuration;
selecting a first transaction from the transactions;
generating a warm start matrix configuration that includes a solution associated with a first matrix configuration stored in the first transaction; and
executing the warm start matrix configuration in a quantum annealer identified in the first transaction.

2. The method of claim 1, wherein the current matrix configuration comprises a QUBO configuration.

3. The method of claim 2, wherein each of the transactions comprises a QUBO configuration, a quantum annealer, a solution, and parameters.

4. The method of claim 3, further comprising incorporating the solution included in the first transaction into the QUBO configuration to generate the warm start configuration, which includes a warm-start QUBO configuration.

5. The method of claim 4, wherein the warm-start QUBO configuration is represented as: H(t=0,x=x*ᵢ)=α(t)·(x^{T}Qᵢx)+β(t)·(x^{T}Qx).

6. The method of claim 1, further comprising generating embedded QUBO configurations using an embedding mechanism, wherein the transactions include the embedded QUBO configurations.

7. The method of claim 6, further comprising training the embedding mechanism using historical QUBO configurations, wherein the embedding mechanism comprises an autoencoder and wherein an encoder generates embedded QUBO configurations once trained, wherein QUBO configurations input to the encoder are scaled to a same dimension.

8. The method of claim 6, further comprising generating a current embedded QUBO configuration from the current matrix configuration, wherein the transactions are identified by comparing the current embedded QUBO configuration with embedded QUBO configurations stored in the transactions.

9. The method of claim 8, further comprising identifying k similar transactions based on a cosine distance metric.

10. The method of claim 1, further comprising updating the database with a new transaction that includes the warm start matrix configuration, the quantum annealer, a solution to the current quantum job, and parameters.

11. A non-transitory storage medium having stored therein instructions that are executable by one or more hardware processors to perform operations comprising:
receiving a quantum job at an orchestration engine;
determining a current matrix configuration associated with the quantum job;
identifying transactions stored in a database that include matrix configurations similar to the current matrix configuration;
selecting a first transaction from the transactions;
generating a warm start matrix configuration that includes a solution associated with a first matrix configuration stored in the first transaction; and
executing the warm start matrix configuration in a quantum annealer identified in the first transaction.

12. The non-transitory storage medium of claim 11, wherein the current matrix configuration comprises a QUBO configuration.

13. The non-transitory storage medium of claim 12, wherein each of the transactions comprises a QUBO configuration, a quantum annealer, a solution, and parameters.

14. The non-transitory storage medium of claim 13, further comprising incorporating the solution included in the first transaction into the QUBO configuration to generate the warm start configuration, which includes a warm-start QUBO configuration.

15. The non-transitory storage medium of claim 14, wherein the warm-start QUBO configuration is represented as: H(t=0, x=x*ᵢ)=α(t)·(x^{T}Qᵢx)+β(t)·(x^{T}Qx).

16. The non-transitory storage medium of claim 11, further comprising generating embedded QUBO configurations using an embedding mechanism, wherein the transactions include the embedded QUBO configurations.

17. The non-transitory storage medium of claim 16, further comprising training the embedding mechanism using historical QUBO configurations, wherein the embedding mechanism comprises an autoencoder and wherein an encoder generates embedded QUBO configurations once trained, wherein QUBO configurations input to the encoder are scaled to a same dimension.

18. The non-transitory storage medium of claim 16, further comprising generating a current embedded QUBO configuration from the current matrix configuration, wherein the transactions are identified by comparing the current embedded QUBO configuration with embedded QUBO configurations stored in the transactions.

19. The non-transitory storage medium of claim 18, further comprising identifying k similar transactions based on a cosine distance metric.

20. The non-transitory storage medium of claim 11, further comprising updating the database with a new transaction that includes the warm start matrix configuration, the quantum annealer, a solution to the current quantum job, and parameters.
